(19) United States
(12) Patent Application Publication
(10) Pub. No.: US 2023/0225283 A1
(43) Pub. Date: Jul. 20, 2023

(54) SYSTEM AND COMPUTER-IMPLEMENTED METHOD FOR MONITORING OPERATING PRESSURE IN A MILKING INSTALLATION, COMPUTER PROGRAM AND NON-VOLATILE DATA CARRIER

(71) Applicant: DeLaval Holding AB, Tumba (SE)

(72) Inventor: Peter REHNSTRÖM, Tumba (SE)

(21) Appl. No.: 18/010,175

(22) PCT Filed: Jun. 18, 2021
(86) PCT No.: PCT/SE2021/050600

§ 371 Date: Dec. 13, 2022

(30) Foreign Application Priority Data
Jun. 22, 2020 (SE) 2050741-4

(51) Int. Cl. A01J 5/007; G01M 3/26

(52) U.S. Cl. CPC A01J 5/007; G01M 3/26

(57) ABSTRACT

A system and method for monitoring at least one operating pressure in a milking installation by a pressure sensor measuring values of a pressure level in a component of a milking point of the milking installation, the pressure level being indicative of the at least one operating pressure to be monitored. A processing node generates monitoring data representing a series of measured values of the pressure level, and the monitoring data contains temporal indicators designating a respective timestamp indicative of a point in time when a value of the pressure level was measured. The temporal indicators serve as a basis for triggering at least one alarm, such as when a timestamp indicates that the pressure level was measured to a value outside of an acceptable range of values at the point in time indicated by the timestamp.

### TECHNICAL FIELD

The present invention relates generally to automatic milking of animals. In particular, the invention relates to a system for monitoring at least one operating pressure in a milking installation and a corresponding computer-implemented method. The invention also relates to a computer program implementing the proposed method and a non-volatile data carrier storing the computer program.

### BACKGROUND

Today's automatic milking arrangements are highly complex installations, the scale of which gradually becomes larger and which to an increasing degree involves remote monitoring of various functionalities and statuses. Below follows a couple of examples of such testing and monitoring solutions.

US2009/0177418 describes dynamic/wet testing of a milking machine, i.e. during extraction of milk from at least one animal. The testing arrangement includes a number of sensors, which are adapted to register a vacuum pressure at a respective test point in at least one fluid conduit of the milking machine. An analysis unit of the testing arrangement determines at least one pressure difference between the vacuum pressures registered in at least two of the test points being positioned on a respective side of at least one component in the milking machine with respect to a fluid flow through the at least one component to establish a vacuum drop over this component. The unit compares the vacuum drop with a threshold value to conclude whether a test condition is fulfilled. A notification is generated with respect to any component for which the condition is not fulfilled. Thus, for instance an appropriate corrective action can be carried out.

US 2011/0308627 shows a system and method for managing an agricultural device connected to a network. Here, operational data relating to the agricultural device are collected, and an access right in respect of the collected operational data is granted to an entity connected to the network. Data are received from the entity in response to the access right, and the agricultural device is managed on the basis of the collected operational data and the data from the entity. The method may be implemented for managing multiple agricultural devices, and may be implemented in a computer readable medium. In one embodiment, the operational data relates to clinical mastitis detection.

Although the above solutions may provide useful means to monitor milking installations, they do not fulfill all the needs of surveillance. For example, it has been found that the milk extraction can be made more efficient and animal-friendly if the vacuum pressure is elevated to a so-called boost level during a peak-flow phase of the milking procedure. However, it is very important that the boost level vacuum pressure is not applied excessively, or in inappropriate phases of the milking procedure. Consequently, it is essential that the different levels of vacuum pressure of a milking installation can be adequately monitored, especially in large installations where the human intervention is relatively low.

### SUMMARY

The object of the present invention is therefore to provide a reliable solution for pressure monitoring in a milking installation.

According to one aspect of the invention, the object is achieved by a system for monitoring at least one operating pressure in a milking installation. The system includes a pressure sensor and a processing node. The pressure sensor is configured to measure values of a pressure level in a component of the milking installation, which pressure level is indicative of the at least one operating pressure.

Here, the term “operating pressure” is understood to designate the pressure delivered by the system, for example to a particular milking point.

The processing node is communicatively connected to the pressure sensor, for instance via a wireless link, and is configured to generate monitoring data representing a series of measured values of the pressure level. The monitoring data contains temporal indicators designating a respective timestamp indicative of a point in time when a value of the pressure level was measured. The temporal indicators serve as a basis for triggering alarms, for example relating to a timestamp indicating that an excessive pressure level was measured at the point in time indicated by the timestamp.

This system is advantageous because ensures that proper vacuum pressure levels can be maintained throughout the milking procedure. Consequently, milk can be extracted efficiently while keeping the risk of animal injuries low.

According to one embodiment of this aspect of the invention, the processing node is configured to trigger at least one local alarm based on the temporal indicators. At least one of these local alarms is triggered if one of the timestamps indicates that the pressure level was measured to a value outside of an acceptable range at the point in time indicated by the timestamp. Thus, the pressure levels can be monitored very precisely at all times.

According to another embodiment of this aspect of the invention, the system further includes a central node. The processing node is configured to forward the monitoring data to the central node, and the central node is configured to trigger at least one central alarm based on the temporal indicators. Analogous to the above, at least one of the at least one central alarm is triggered if one of the timestamps indicates that the pressure level was measured to a value outside of an acceptable range of values at the point in time indicated by said timestamp.

According to yet one embodiment of this aspect of the invention, the system includes a storage resource that is communicatively connected to the central node. The storage resource is configured to store the monitoring data and information about any of the at least one central alarm that have been generated. Thus, an operator can gain knowledge about historic pressure variations in the milking installation. The operator can also readily determine if the operating pressure has deviated from acceptable ranges in terms of level, timing and/or overall duration.

According to still another embodiment of this aspect of the invention, the processing node is configured to initiate forwarding of the monitoring data to the central node in response to a start signal indicating a beginning of a milking session to be carried out by the milking installation. Preferably, the processing node is configured to continue forwarding the monitoring data to the central node until an abort signal is received, which abort signal indicates an end of said milking session. Thereby, the central node exclusively receives monitoring data that have been produced when the milking installation is used for milk extraction, while for example the pressure levels registered during cleaning are excluded.

According to another embodiment of this aspect of the invention, the central node is configured to trigger at least one of the central alarms if the monitoring data indicates that an operating pressure has been applied excessively. In other words, the central alarm may be triggered if one of the at least one operating pressure has been applied during a total extension of a high-pressure part of a milking time, which high-pressure part exceeds a threshold measure, say a predetermined percentage of the milking session. This provides a means of supervising that the at least one operating pressure is applied in an acceptable manner.

According to further embodiments of this aspect of the invention, the pressure sensor is arranged either in a dry or a liquid-containing space of the component. In the former case, the dry space is in direct fluid connection with at least one conduit in which at least one operating pressure exists. Thus, the at least one operating pressure can be monitored accurately at distinct levels. In the latter case, the liquid-containing space is in indirect fluid connection with the at least one conduit in which the at least one operating pressure exists. This renders it somewhat more complex to derive the operating pressure, but provides a high degree of flexibility in terms of where the pressure sensor can be monitored.

In case the pressure sensor is arranged in the liquid-containing space of the component, the component may be a milk conduit, a claw of a milking device, a teat cup, a shut-off valve or any other suitable component of the milking installation.

According to yet another embodiment of this aspect of the invention, the pressure sensor is configured to measure the values of the pressure level at a first frequency. The pressure sensor is further configured to transmit representative data reflecting the measured values of the pressure level to the processing node at a second frequency being lower than the first frequency. Hence, high-quality data can be acquired without overloading the central node or the connection thereto.

Preferably, the representative data contains: a rolling average, a maximum and/or a minimum of the measured values of the pressure level since a previous transmission.

According to another aspect of the invention, the object is achieved by a computer-implemented method of monitoring at least one operating pressure in a milking installation. The method involves receiving, from a pressure sensor, measured values of a pressure level in a component of the milking installation. The pressure level is indicative of the at least one operating pressure to be monitored. The measured values of the pressure level are processed to generate monitoring data representing a series of measured values of the pressure level. The monitoring data contain temporal indicators designating a respective timestamp indicative of a point in time when a value of the pressure level was measured. The temporal indicators, in turn, serve as a basis for triggering at least one alarm. The advantages of this method, as well as the preferred embodiments thereof, are apparent from the discussion above with reference to the system.

According to a further aspect of the invention, the object is achieved by a computer program loadable into a non-volatile data carrier communicatively connected to a processing unit. The computer program includes software for executing the above method when the program is run on the processing unit.

According to another aspect of the invention, the object is achieved by a non-volatile data carrier containing the above computer program.

Further advantages, beneficial features and applications of the present invention will be apparent from the following description and the dependent claims.

### BRIEF DESCRIPTION OF THE DRAWINGS

The invention is now to be explained more closely by means of preferred embodiments, which are disclosed as examples, and with reference to the attached drawings.

FIG. 1 shows a block diagram over a system according to a first embodiment of the invention;

FIG. 2 shows a graph illustrating how a measured pressure level may vary over time during the milking of an animal according to the embodiment of FIG. 1;

FIG. 3 shows a block diagram over a system according to a second embodiment of the invention;

FIG. 4 shows a graph illustrating how a measured pressure level may vary over time during the milking of an animal according to the embodiment of FIG. 3;

FIG. 5 schematically represents the processing node according to one embodiment of the invention; and

FIG. 6 illustrates, by means of a flow diagram, the general method according to the invention.

### DETAILED DESCRIPTION

In FIG. 1, we see a system for monitoring the operating pressures P_{1OP}, P_{2OP} and P_{3OP} that exist in first, second and third conduits 151, 152 and 153 respectively of a milking installation. Valves 161, 162 and 163 connect each of the conduits 151, 152 and 153 to a common control valve 160 via which either of the operating pressures P_{1OP}, P_{2OP} and P_{3OP} is applied to a component 110 of the milking installation, for instance a shut-off valve for controlling the extraction of milk at a milking point.

Alternatively, each of the operating pressures P_{1OP}, P_{2OP} and P_{3OP} may be produced based on a basic pressure P that is regulated by a pressure regulator 160b to the respective levels P_{1OP}, P_{2OP} and P_{3OP} and delivered to the component 110 as shown by the dashed lines. Naturally, this design may also be used for a dynamic adjustment of the pressure level P_{DYN} being delivered to the component 110, i.e. delivery of any other fixed pressure level or a varying pressure, which for example is adjusted in response to one or more measured parameters.

A pressure sensor 115 is arranged in the component 110, which pressure sensor 115 is configured to measure values of a pressure level P_{md} in the component 110. The pressure level P_{md} is indicative of the at least one operating pressure P_{1OP}, P_{2OP} and/or P_{3OP} depending on which operating pressure that is being applied via the common control valve 160, or the pressure regulator 160b. Here, the pressure sensor 115 is arranged in a dry space 111 of the component 110, which dry space 111 connects to a wet space, i.e. a liquid-containing space 113 of the component 110, via a diaphragm 112, so as to effect milk extraction via conduits M connected to the animal. The dry space 111 is in direct fluid connection with the conduits 151, 152 and 153 in which the operating pressures P_{1OP}, P_{2OP} P_{3OP} respectively exist.

A processing node 125 is communicatively connected 120 to the pressure sensor 115, for instance via a wireless connection based on radio or optical technique, or a wired connection implemented by electric cable or optic fiber. The processing node 125 is configured to generate monitoring data P_{md}(tₛ) representing a series of measured values of the pressure level P_{md}. The monitoring data P_{md}(tₛ) includes temporal indicators tₛ designating a respective timestamp indicative of a point in time when a value of the pressure level P_{md} was measured. The temporal indicators tₛ are included to serve as a basis for triggering at least one alarm as will be explained below.

During a milking procedure, a modern milking machine typically applies a vacuum pressure level that varies over time in order to match the variations in milk flow from the animal's udder. For example, to instigate the milk flow, a so-called stimulation vacuum may be applied. Shortly thereafter, it is expected that a considerable milk flow has been brought about, and therefore a standard milking vacuum level is applied. Analogously, when the milk flow decreases towards the end of the milking procedure, it is often preferable to reduce the vacuum pressure, i.e. adjust the sub pressure to a level closer to the atmospheric pressure, in order to not risk harming the animal's teats.

The applicant has found that the milk extraction can be made even more efficient, if yet another vacuum level is introduced, namely a so-called boost vacuum, where the sub pressure is further increased in relation to the standard milking vacuum level, i.e. to a level even further below the atmospheric pressure. Thus, a total of three different vacuum levels are applied in addition to the atmospheric pressure level exerted on the teats when they are not being milked. For example, a first operating pressure P_{1OP}, a so-called stimulation vacuum, may be applied to instigate the milking. Then, a second operating pressure P_{2OP}, a so-called standard vacuum, may be applied to match a subsequently increased milk flow. Thereafter, during a top-flow period, the boost vacuum is applied. Analogous to the above, towards the end of the milking procedure the sub pressure applied is preferably gradually decreased, for instance in three steps corresponding to the levels applied at the beginning of the procedure.

As mentioned above, the operating pressures P_{1OP}, P_{2OP} and P_{3OP} may either originate from separate fluid connection with the conduits 151, 152 and 153 respectively, or be produced based on a common basic pressure P that is regulated by a pressure regulator 160b to the said levels P_{1OP}, P_{2OP} and P_{3OP}.

When varying the vacuum pressure like this, it is important that the variations are adequately timed relative to the animal's milk-flow curve, i.e. that the vacuum pressure level follows the differing quantities of milk flowing from the teats. Such monitoring is especially critical if a boost vacuum is used.

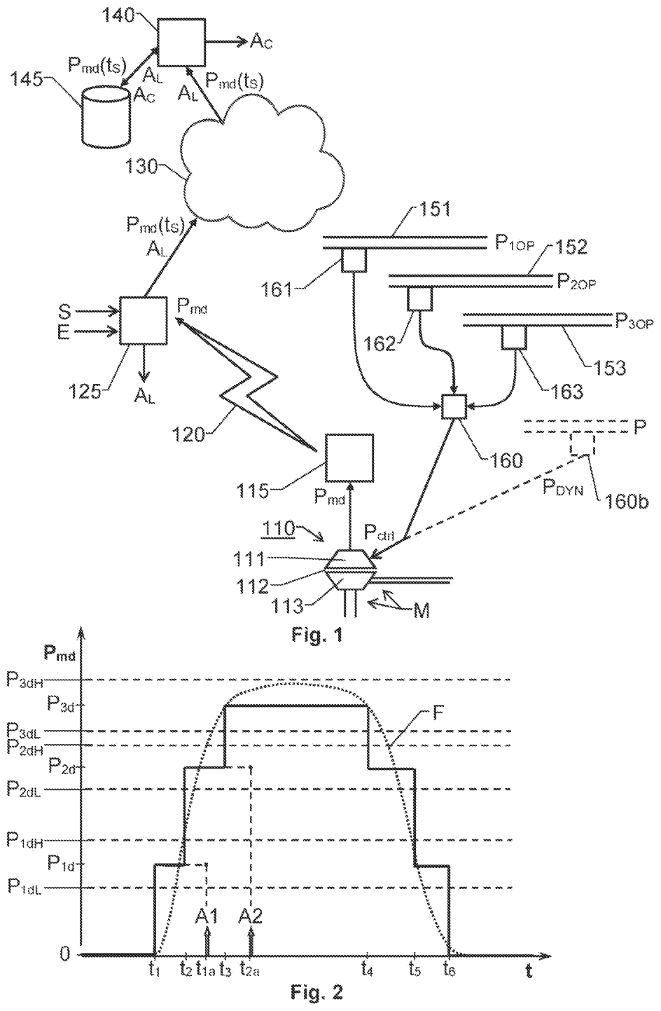

FIG. 2 shows a graph illustrating how a measured pressure level P_{md} may vary over time t during a milking procedure effected via the milking installation of FIG. 1. Here, it should be noted that measured pressure level P_{md} represents a vacuum pressure, i.e. a sub-atmospheric pressure, where zero represents the atmospheric pressure level and a pressure level P_{md} of larger vacuum magnitude is represented by a larger positive value than a pressure level P_{md} of smaller vacuum magnitude. In other words, the P_{md} axis represents negative pressure deviations from the atmospheric pressure level. A dotted line symbolizes an estimated milk flow F as a function of time t corresponding to the measured pressure level P_{md}.

In FIG. 2, a first reference level P_{1d} designates a measured pressure level P_{md} constituting the stimulation vacuum, which is provided by the first operating pressure P_{1OP} in the first conduit 151; a second reference level P_{2d} designates a measured pressure level P_{md} constituting the standard vacuum, which is provided by the second operating pressure P_{2OP} in the second conduit 152; and a third reference level P_{3d} designates a measured pressure level P_{md} constituting the boost vacuum, which is provided by the third operating pressure P_{3OP} in the third conduit 153. According to embodiments of the invention, the atmospheric pressure level is preferably defined as any pressure below 4 kPa; the first reference level P_{1d} is typically around 34 kPa, and preferably between 20 and 50 kPa, however at least 3 kPa below the second reference level P_{2d}; the second reference level P_{2d} is typically around 43 kPa, and preferably between 20 and 50 kPa, however at least 2 kPa below the third reference level P_{3d}; and the third reference level P_{3d} is typically around 49 kPa, and preferably between 40 and 55 kPa.

Above and below each of the reference levels P_{1d}, P_{2d} and P_{3d} a respective upper and lower threshold P_{1dL}, P_{1dH}; P_{2dL}, P_{2dH}; and P_{3dL}, P_{3dH} respectively define intervals outside which the processing node 125 will trigger alarms. In particular, according to one embodiment of the invention, the temporal indicators form a basis for triggering at least one alarm as follows. The processing node 125 is configured to trigger a local alarm A_{L} based on the temporal indicators if a timestamp indicates that the pressure level P_{md} was measured to a value outside of an acceptable range of values as defined by the upper and lower thresholds P_{1dL}, P_{1dH}, P_{2dL}, P_{2dH} and P_{3dL}, P_{3dH}, indicated by the timestamp in question.

For example, the milking procedure may be prescribed to start by applying the first operating pressure P_{OP1} for a first period, say 30 seconds. Then, the second operating pressure P_{OP2} shall be applied for a second period, say 25 seconds. Thereafter, the third operating pressure P_{OP3} is applied until an end criterion is fulfilled, for instance relating to the milk flow. In response to the end criterion being fulfilled, the pressure is stepwise decreased analogous to how it was elevated in the beginning of the procedure. We assume that the processing node 125 generates monitoring data containing a first timestamp t₁ when the measured pressure level P_{md} indicates that the pressure increases from the atmospheric level to the first reference levels P_{1d} representing the first operating pressure P_{OP1} providing the stimulation vacuum In a nominal scenario, the processing node 125 should generate monitoring data containing a second timestamp t₂ when the measured pressure level P_{md} indicates that the pressure increases from the first operating pressure P_{OP1} to the second operating pressure P_{OP2} providing the standard vacuum, where the second timestamp t₂ designates a point in time around one second later than the point in time designated by the first timestamp t₁. In the nominal scenario, the processing node 125 should further generate monitoring data containing a third timestamp t₃ when the measured pressure level P_{md} indicates that the pressure increases from the second operating pressure P_{OP2} to the third operating pressure P_{OP3} providing the boost vacuum, where the third timestamp t₃ designates a point in time around one second later than the point in time designated by the second timestamp t₂.

To monitor the timing of the above pressure changes, the processing node 125 may perform temporal checks as follows. If, at a point in time t₁ₐ after the point in time indicated by the first timestamp t₁, say two seconds later, the measured pressure level P_{md} is not within the acceptable pressure range P_{2dL}-P_{2dH} for the second reference level P_{2d}, the processing node 125 is configured to trigger a first alarm A1, for instance in the form of a local alarm A_{L}. Analogously, if, at a point in time t₂ₐ after the point in time indicated by the second timestamp t₂, say three seconds later, the measured pressure level P_{md} is not within the acceptable pressure range P_{3dL}-P_{3dH} for the third reference level P_{3d}, the processing node 125 is configured to trigger a second alarm A2, for instance in the form of a local alarm A_{L}.

According to one embodiment of the invention, the system also includes a central node 140. The processing node 125 is further configured to forward the monitoring data P_{md}(tₛ) to the central node 140. Analogous to the processing node 125, the central node 140 is configured to trigger alarms. Specifically, the central node 140 is configured to trigger at least one central alarm A_{C} based on the temporal indicators tₛ. At least one of the at least one central alarm A_{C} is triggered if one of the timestamps t₁, t₂, t₂ₐ, t₃, t₃ₐ, t₄, t₅ or t₆ indicates that the pressure level P_{md} was measured to a value outside of an acceptable range of values at the point in time indicated by the timestamp in question. For example, if, at the point in time t₁ₐ after the point in time indicated by the first timestamp t₁, the measured pressure level P_{md} is not within the acceptable pressure range P_{2dL}-P_{2dH} for the second reference level P_{2d}, the central node 140 is configured to trigger a first alarm A1, for instance in the form of a central alarm A_{L}. Further, if, at the point in time t₂ₐ after the point in time indicated by the second timestamp t₂, the measured pressure level P_{md} is not within the acceptable pressure range P_{3dL}-P_{3dH} for the third reference level P_{3d}, the central node is configured to trigger a second alarm A2, for instance in the form of a central alarm A_{C}.

Preferably, a storage resource 145, for example a digital memory unit, is communicatively connected to the central node 140. The storage resource 145 is configured to store the monitoring data P_{md}(tₛ) and any central alarm A_{C} that have been generated. Thus, service personnel and/or the farmer may gain access to log data describing how the operating pressure has fluctuated during historic milking sessions in the milking installation. Thereby, decisions can be taken relating to when service and repair actions should be taken.

According to one embodiment of the invention, the pressure sensor 115 is configured to measure the values of the pressure level P_{md} at a first frequency, say 100 Hz, or at least within a range from 10 to 1000 Hz, and transmit representative data reflecting the measured values of the pressure level P_{md} to the processing node 125 at a second frequency that is lower than the first frequency, say 1 Hz, or at least within a range from 0.001 to 10 Hz. The representative data may here contain: a rolling average of the measured values of the pressure level P_{md} since a previous transmission, a maximum of the measured values of the pressure level P_{md} since a previous transmission, and/or a minimum of the measured values of the pressure level P_{md} since a previous transmission. The previous transmission is preferably a most recent previous transmission of the representative data. However, according to the invention, various overlap in the transmitted data are also conceivable, meaning that the above-mentioned previous transmission is the penultimate, or an even earlier transmission.

According to one embodiment of the invention, the processing node 125 is configured to initiate forwarding of the monitoring data P_{md}(tₛ) to the central node 140 in response to a start signal S, which indicates a beginning of a milking session to be carried out by the milking installation. The start signal S, in turn, may be produced by a cleaning unit for the milking installation, for example a signal indicating that a milking session has started or a cleaning procedure has been completed. Alternatively, the start signal S may originate from any other device or function in the milking system indicating that a milking session has started. For example, a milking point controller may generate the start signal S individually for each milking cluster. In such a case, an accelerometer output caused by a movement of the milking cluster may form a basis for the start signal S. As yet another alternative, an operator may cause the start signal S by manually activating a milking session.

The processing node 125 is further preferably configured to continue forwarding the monitoring data P_{md}(tₛ) to the central node 140 until an abort signal E is received, which abort signal E indicates an end of the milking session. Thus, it can be ensured that the central node 140 exclusively receives monitoring data P_{md}(tₛ) generated during the milking session. For example, any monitoring data collected during cleaning can be excluded from the basis for triggering alarms.

According to one embodiment of the invention, the central node 140 is configured to trigger at least one of the at least one central alarm A_{C} if the monitoring data P_{md}(tₛ) indicates that one or more of the operating pressures P_{1OP}, P_{2OP} and/or P_{3OP} has been applied during a total extension of a high-pressure part of a milking time, which high-pressure part exceeds a threshold measure. For example, the central node 140 may be configured to trigger such a central alarm A_{C} if the pressure level P_{md} has been measured to the third reference level P_{3d}, i.e. representing the boost vacuum, during more than 90% of the milking session. Preferably, the threshold measure for the high-pressure part of a milking time is between 60% and 99% of the total duration of a milking session.

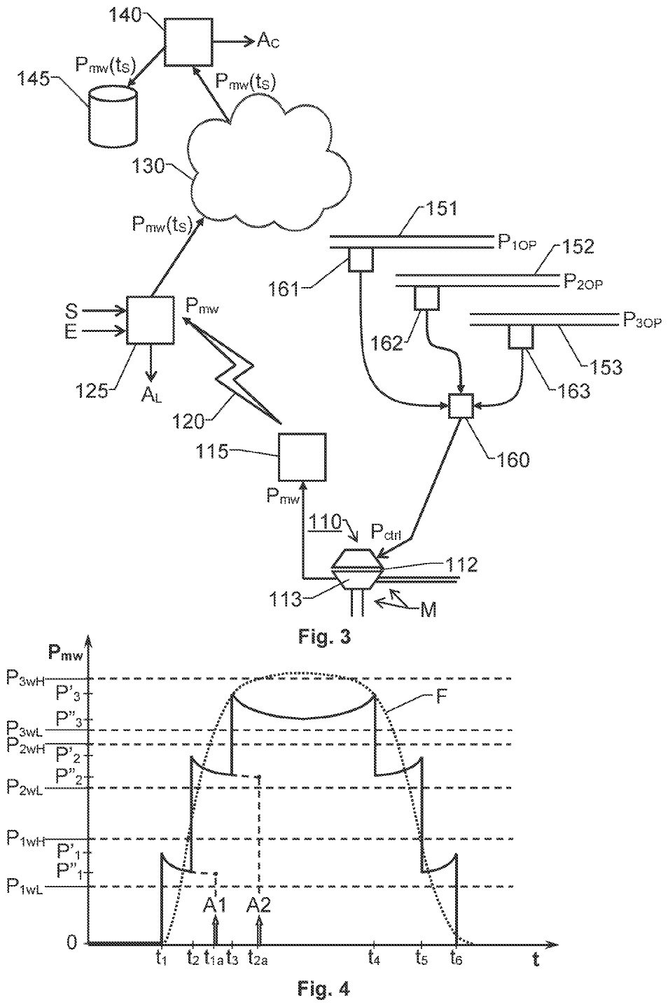

FIG. 3 shows a block diagram over a system according to a second embodiment of the invention. Here, all parts, units and signals that also occur in FIG. 1 designate the same parts, units and signals as described above with reference to FIG. 1. As can be seen, the design in FIG. 3 differs from that in FIG. 1 with respect to where the pressure level is measured, which pressure level is indicative of the operating pressures P_{1OP}, P_{2OP} and P_{3OP} respectively.

In FIG. 3, this pressure level P_{mw} is measured in a liquid-containing space 113 of the shut-off valve component 110, i.e. on the opposite side of the diaphragm 112 relative to where the pressure sensor 115 is arranged in FIG. 1. According to the invention, the pressure sensor 115 may equally well be arranged at any other point on the so-called wet, or milk-containing, side schematically illustrated by conduits M, such as beneath the tip of the animal's teat in a teat cup.

It is somewhat more complicated to measure the pressure level P_{mw} on the wet side because here the pressure level varies depending on the magnitude of the milk flow although the operating pressure applied P_{1OP}, P_{2OP} or P_{3OP} is constant. This, in turn, is due to the fact that the liquid-containing space 113 is only in indirect fluid connection with the conduits 151, 152 or 153 where the operating pressures P_{1OP}, P_{2OP} and P_{3OP} respectively exist.

On the other hand, the pressure level P_{mw} more accurately reflects the pressure level to which the animal's teats are subjected.

FIG. 4 shows a graph illustrating how the measured pressure level P_{mw} may vary over time t during the milking of an animal according to the design shown in FIG. 3. As can be seen, here, for each operating pressure P_{1OP}, P_{2OP} and P_{3OP}, a reference level must be allowed to vary between first and second values P′₁ to P″₁, P′₂ to P″₂ and P′₃ to P″₃ respectively due to said variations in the milk flow.

Nevertheless, the processing node 115 and/or the central node 140 may be configured to trigger first and/or second alarms A1 and/or A2 respectively as described above if, at the points in time t₁ₐ and/or t₂ₐ the measured pressure level P_{mw} is not within an acceptable pressure range P_{2wL}-P_{2wH} or P_{3wL}-P_{3wH} respectively.

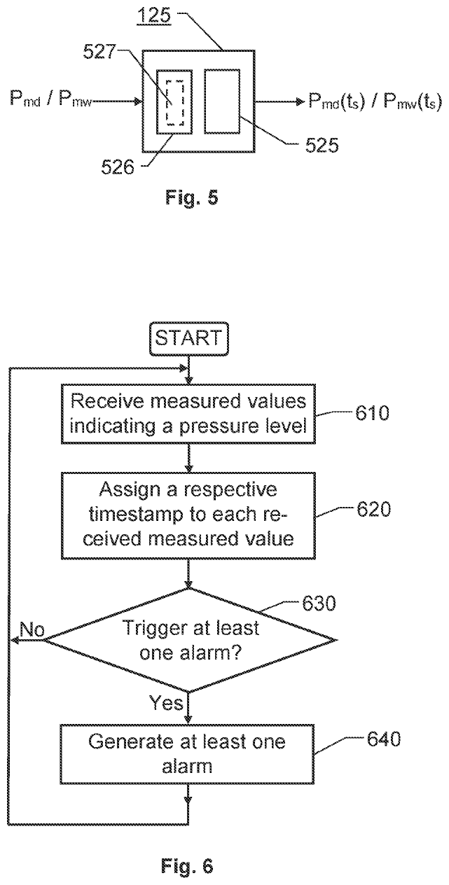

FIG. 5 shows a block diagram over the processing node 125 according to one embodiment of the invention. The processing node 125 is configured to receive measured values of a pressure level, for example P_{md} as described above with reference to FIG. 1, or P_{mw} as described above with reference to FIG. 3, and assign timestamps to generate corresponding the monitoring data P_{md}(tₛ) or P_{mw}(tₛ) respectively. It is generally advantageous if the processing node 125 is configured to effect the above-described procedure in an automatic manner by executing a computer program 527. Therefore, according to this embodiment, the processing node 125 includes a memory unit 525, i.e. non-volatile data carrier, storing the computer program 527, which, in turn, contains software for making processing circuitry in the form of at least one processor 525 in the central control unit 520 execute the above-described actions when the computer program 527 is run on the at least one processor 525.

In order to sum up, and with reference to the flow diagram in FIG. 6, we will now describe the general computer-implemented method according to the invention of monitoring at least one operating pressure in a milking installation.

In a first step 610, at least one measured pressure value is received from one or more pressure sensors. The at least one measured pressure value is indicative of the at least one operating pressure in the milking installation.

A following step 620 assigns a respective timestamp to each of the measured pressure values received. The monitoring data represent a series of measured values of the pressure level including the timestamps indicating a respective time when a particular value of the pressure level was measured, and serve as a basis for triggering at least one alarm.

Subsequently, a step 630 checks if at least one alarm criterion is fulfilled. If so, a step 640 follows; and otherwise, the procedure loops back to step 610.

Step 640 generates at least one alarm in response to an output from step 630. Thereafter, the procedure loops back to step 610.

All of the process steps, as well as any sub-sequence of steps, described with reference to FIG. 6 may be controlled by means of a programmed processor. Moreover, although the embodiments of the invention described above with reference to the drawings comprise processor and processes performed in at least one processor, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the process according to the invention. The program may either be a part of an operating system, or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc) or a semi-conductor ROM, an EPROM (Erasable Programmable Read-Only Memory), an EEPROM (Electrically Erasable Programmable Read-Only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal which may be conveyed directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

The term “comprises/comprising” when used in this specification is taken to specify the presence of stated features, integers, steps or components. However, the term does not preclude the presence or addition of one or more additional features, integers, steps or components or groups thereof.

The invention is not restricted to the described embodiments in the figures, but may be varied freely within the scope of the claims.

1. A system for monitoring at least one operating pressure in a milking installation, the system comprising:
a pressure sensor (115) configured to measure values of a pressure level in a component (110) of a milking point of the milking installation, said pressure level being indicative of said at least one operating pressure; and
a processing node (125) communicatively connected (120) to the pressure sensor (115) and configured to generate monitoring data representing a series of measured values of the pressure level, the monitoring data comprising temporal indicators designating a respective timestamp indicative of a point in time when a value of the pressure level was measured, and the temporal indicators serving as a basis for triggering at least one alarm.

2. The system according to claim 1, wherein the processing node (125) is configured to trigger at least one local alarm based on the temporal indicators, at least one of the at least one local alarm being triggered if one of said timestamps indicates that the pressure level was measured to a value outside of an acceptable range of values at the point in time indicated by said timestamp.

3. The system according to claim 1, further comprising:
a central node (140), the processing node (125) being configured to forward the monitoring data to the central node (140), and the central node (140) being configured to trigger at least one central alarm based on the temporal indicators, at least one of the at least one central alarm being triggered if one of said timestamps indicates that the pressure level was measured to a value outside of an acceptable range of vlues at the point in time indicated by said timestamp.

4. The system according to claim 3, further comprising:
a storage resource (145) communicatively connected to the central node (140), said storage resource (145) configured to store the monitoring data and at least one of the at least one central alarm.

5. The system according to claim 3, wherein the processing node (125) is configured to initiate forwarding of the monitoring data to the central node (140) in response to a start signal (S) indicating a beginning of a milking session to be carried out by the milking installation.

6. The system according to claim 5, wherein the processing node (125) is configured to continue forwading the monitoring data to the central node (140) until an abort signal (E) is received, said abort signal (E) indicating an end of said milking session.

7. The system according to claim 6, wherein the central node (140) is configured to trigger at least one of the at least one central alarm if the monitoring data indicates that one of the at least one operating pressure has been applied during a total extension of a high-pressure part of a milking time, said high-pressure part exceeding a threshold measure.

8. The system according to claim 1, wherein the pressure sensor (115) is arranged in a dry space (111) of the component (110), said dry space (111) being in direct fluid connection with at least one conduit in which said at least one operating pressure exists.

9. The system according to claim 1, wherein the pressure sensor (115) is arranged in a liquid-containing space (113) of the component (110), said liquid-containing space (113) being in indirect fluid connection with at least one conduit in which said at least one operating pressure exists.

10. The system according to claim 1, wherein the pressure sensor (115) is configured to measure the values of the pressure level at a first frequency, and to transmit representative data reflecting the measured values of the pressure level to the processing node (125) at a second frequency being lower than the first frequency.

11. The system according to claim 10, wherein the representative data comprises at least one of:
a rolling average of the measured values of the pressure level since a previous transmission,
a maximum of the measured values of the pressure level since a previous transmission, and
a minimum of the measured values of the pressure level since a previous transmission.

12. A computer-implemented method of monitoring at least one operating pressure in a milking installation, the method comprising:
receiving from a pressure sensor (115) measured values of a pressure level in a component (110) of a milking point of the milking installation, said pressure level being indicative of said at least one operating pressure; and
processing the measured values of the pressure level and generating monitoring data representing a series of measured values of the pressure level,
the monitoring data comprising temporal indicators designating a respective timestamp indicative of a point in time when a value of the pressure level was measured, and the temporal indicators serving as a basis for triggering at least one alarm.

13. The method according to claim 12, further comprising:
determining if a timestamp of one of said timestamps indicates that the pressure level was measured to a value outside of an acceptable range of values at the point in time indicated by said timestamp; and
determining that said timestamp indicates that the pressure level was measured to a value outside of an acceptable range of values at the point in time indicated by said timestamp, and subsequently triggering local alarm.

14. The method according to any one of the claim 12, further comprising:
forwarding the monitoring data to a central node (140);
determining if a timestamp of one of said timestamps indicates that the pressure level was measured to a value outside of an acceptable range of values at the point in time indicated by said timestamp; and
determining that said timestamp indicates that the pressure level was measured to the value outside of the acceptable range of values at the point in time indicated by said timestamp, and subsequently triggering in the central node a central alarm.

15. The method according to claim 14, further comprising:
determining receipt of a start signal (S) indicating a beginning of a milking session to be carried out by the milking installation, and subsequently initiating the forwarding of the monitoring data to the central node.

16. The method according to claim 15, further comprising:
determining receipt of an abort signal (E), said abort signal (E) indicating an end of said milking session, and subsequently stopping the forwarding of the monitoring data to the central node.

17. The method according to claim 16, further comprising:
determining if the monitoring data indicates that one of the at least one operating pressure has been applied during a total extension of a high-pressure part of a milking time, said high-pressure part exceeding a threshold measure; and
determining that the monitoring data indicates that the one of the at least one operating pressure has been applied during the total extension of a high-pressure part of the milking time, and subsequently triggering in the central node an other central alarm.

18. The method according to claim 12, further comprising:
measuring the values of the pressure level in a dry space (111) of the component (110), said dry space (111) being in direct fluid connection with at least one conduit in which said at least one operating pressure exists.

19. The method according to claim 12, further comprising:
measuring the values of the pressure level in a liquid-containing space (113) of the component (110), said liquid-containing space (113) being in indirect fluid connection with at least one conduit in which said at least one operating pressure exists.

20. The method according to claim 12, further comprising:
measuring, in the pressure sensor (115), the values of the pressure level (P_{md}, P_{mw}) at a first frequency; and
transmitting representative data reflecting the measured values of the pressure level (P_{md}, P_{mw}) from the pressure sensor (115) at a second frequency lower than the first frequency.

21. The method according to claim 20, wherein the representative data comprises at least one of:
a rolling average of the measured values of the pressure level since a previous transmission,
a maximum of the measured values of the pressure level since a previous transmission, and
a minimum of the measured values of the pressure level since a previous transmission.

22. (canceled)

23. A non-transitory computer-readable data medium (526) having recorded thereon a computer program (527) that, upon execution by a processor of a computer, executes the method according to claim 12.

24. The system according to claim 1, wherein the component is any one of a milk conduit, a claw of a milking device, a teat cup, and a shut-off valve.

25. The method according to claim 12, wherein the component is any one of a milk conduit, a claw of a milking device, a teat cup, and a shut-off valve.
